(19) United States
(12) Patent Application Publication
(10) Pub. No.: US 2025/0297689 A1
(43) Pub. Date: Sep. 25, 2025

(54) RELIEF VALVE

(71) Applicant: HONDA MOTOR CO., LTD., Tokyo (JP)

(72) Inventor: Yuki Wada, Wako-shi (JP)

(21) Appl. No.: 19/078,770

(22) Filed: Mar. 13, 2025

(30) Foreign Application Priority Data
Mar. 19, 2024 (JP) 2024-043003

(51) Int. Cl. F16K 17/04

(52) U.S. Cl. CPC F16K 17/04

(57) ABSTRACT

A relief valve includes a cylinder having a cavity, a valve element displaceable in the axial direction of the cylinder in the cavity, and a spring member for urging the valve element toward a valve seat of the cylinder. The head portion of the valve element has a first surface axially opposed to the inlet, a second surface axially opposed to the valve seat, a protrusion projecting from between the first surface and the second surface toward the valve seat, and a passage provided in the protrusion.

### CROSS-REFERENCE TO RELATED APPLICATIONS

This application is based upon and claims the benefit of priority from Japanese Patent Application No. 2024-043003 filed on Mar. 19, 2024, the contents of which are incorporated herein by reference.

### BACKGROUND OF THE INVENTION

### Field of the Invention

The present disclosure relates to a relief valve.

### Description of the Related Art

In recent years, in order to ensure that more people will have access to affordable, reliable, sustainable, and advanced energy, research and development into energy efficiency has been conducted in various fields, including the field of fluid circuits. For example, as disclosed in JP 2001-012627 A, a relief valve is disposed in a fluid circuit such as a hydraulic circuit so as not to exceed a predetermined pressure (set value).

### SUMMARY OF THE INVENTION

In a relief valve, it is desired to effectively suppress hunting caused by pressure fluctuation, and stabilize valve behavior.

The present disclosure has the object of solving the aforementioned problem.

According to an aspect of the present disclosure, there is provided a relief valve including: a cylinder including a peripheral wall, a cavity formed inwardly of the peripheral wall, an inlet provided at one end of the peripheral wall and communicating with the cavity, a valve seat surrounding, in the cavity, the inlet, and an outlet communicable with the inlet via the cavity; a valve element that is displaceable inside the cavity in an axial direction of the cylinder, includes a head portion provided with a seating face facing toward the valve seat, and abuts on the valve seat at the seating face in a state where the relief valve is closed; and a spring member configured to urge the valve element toward the valve seat of the cylinder, wherein the head portion includes a first surface facing toward the inlet in the axial direction, a second surface facing toward the valve seat in the axial direction, a protrusion protruding from between the first surface and the second surface toward the valve seat and including the seating face, and a passage formed in the protrusion and connecting the first surface and the second surface.

According to the relief valve of the present disclosure, because the head portion of the valve element is provided with the protrusion with the passage, a difference in pressure receiving area before and after valve opening can be made small. Therefore, the pressure fluctuation (pressure pulsation) before and after the valve opening can be reduced.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of a liquid supply system;

FIG. 2 is a cross-sectional view of a relief valve;

FIG. 3 is an enlarged sectional view of the relief valve;

FIG. 4 is a perspective view of a valve element; and

FIG. 5 is an enlarged view of an outlet of the cylinder and the vicinity thereof.

### DETAILED DESCRIPTION OF THE INVENTION

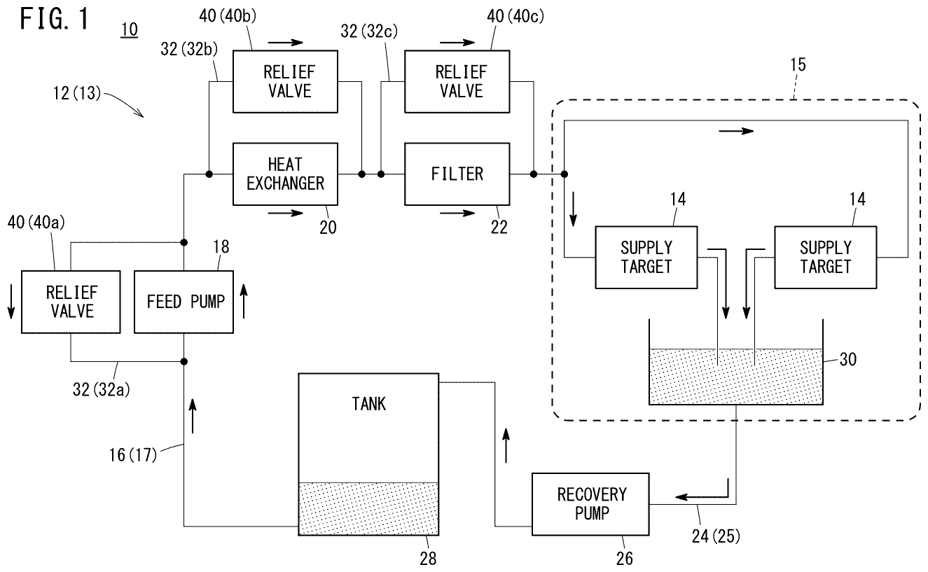

The liquid supply system 10 shown in FIG. 1 includes a fluid circuit 12. The fluid circuit 12 is a liquid supply device 13. The fluid circuit 12 is configured as a lubrication circuit. The fluid medium in the fluid circuit 12 is a liquid. In the lubrication circuit, a lubricating liquid flows as the fluid medium. The lubricating liquid is, for example, oil. The liquid is supplied to a supply target 14. A device 15 including the supply target 14 is, for example, a rotating electric machine. The rotating electric machine is an electric motor or a generator. The supply target 14 is, for example, a sliding portion, a bearing, or the like.

The liquid supply device 13 includes a supply line 16, a feed pump 18, a heat exchanger 20, a filter 22, a recovery line 24, a recovery pump 26, and a tank 28.

The liquid is supplied to the supply target 14 through the supply line 16. The supply line 16 may be a pipe 17. The feed pump 18, the heat exchanger 20, and the filter 22 are provided on the supply line 16. The feed pump 18 generates a pressure to supply the liquid. The feed pump 18 feeds the liquid stored in the tank 28 to the supply target 14.

The heat exchanger 20 changes the temperature of the liquid flowing through the supply line 16. The heat exchanger 20 cools, for example, the liquid flowing through the supply line 16. If cooling or heating of the liquid is not required, the supply line 16 can be devoid of the heat exchanger 20. The filter 22 removes foreign matter in the liquid flowing through the supply line 16.

The liquid that has passed through the supply target 14 is recovered through the recovery line 24. The recovery line 24 may be a pipe 25. The recovery pump 26 is provided on the recovery line 24. The recovery pump 26 feeds the liquid stored in a storage 30 of the device 15 to the tank 28. The tank 28 stores the liquid.

In order to protect the fluid circuit 12 of the liquid supply device 13, the liquid supply device 13 further comprises a relief valve 40. A bypass line 32a is provided in parallel with the feed pump 18. A relief valve 40a is disposed on the bypass line 32a. In the case where the pressure of the liquid exceeds a set value, the relief valve 40a is opened, and then a part of the liquid flows into the bypass line 32a and is returned to the inlet side of the feed pump 18. Thus, the pressure is adjusted to be equal to or lower than the set value.

A bypass line 32b is provided in parallel with the heat-exchanger 20. A relief valve 40b is disposed on the bypass line 32b. In the case where the pressure of the liquid exceeds a set value, the relief valve 40b is opened, and then a part of the liquid flows into the bypass line 32b toward the downstream side of the heat exchanger 20 to bypasses the heat exchanger 20. Thus, the pressure of the liquid is adjusted to be equal to or lower than the set value, and the heat exchanger 20 is protected.

A bypass line 32c is provided in parallel with the filter 22. A relief valve 40c is disposed on the bypass line 32c. In the case where the pressure of the liquid exceeds a set value, the relief valve 40c is opened, and then the liquid flows into the bypass line 32c toward the downstream side of the filter 22 to bypasses the filter 22. Thus, the pressure of the liquid is adjusted to be equal to or lower than the set value, and the filter 22 is protected.

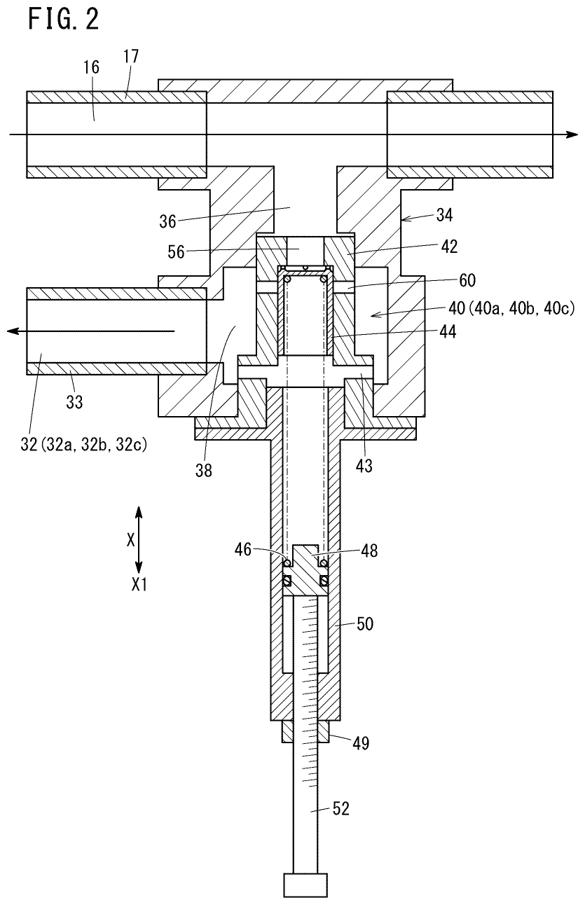

As shown in FIG. 2, the relief valve 40 is fixed to a valve support member 34. The pipe 17 constituting the supply line 16 and the pipe 33 constituting the bypass line 32 are connected to the valve support member 34. The valve support member 34 has an inflow passage 36 and an outflow passage 38. The inflow passage 36 communicates with the supply line 16. The outflow passage 38 communicates with the bypass line 32. The outflow passage 38 may annularly surround the relief valve 40.

The relief valve 40 includes a cylinder 42, a valve element 44, a spring member 46, a spring receiving portion 48, a holder 50, and an adjustment member 52.

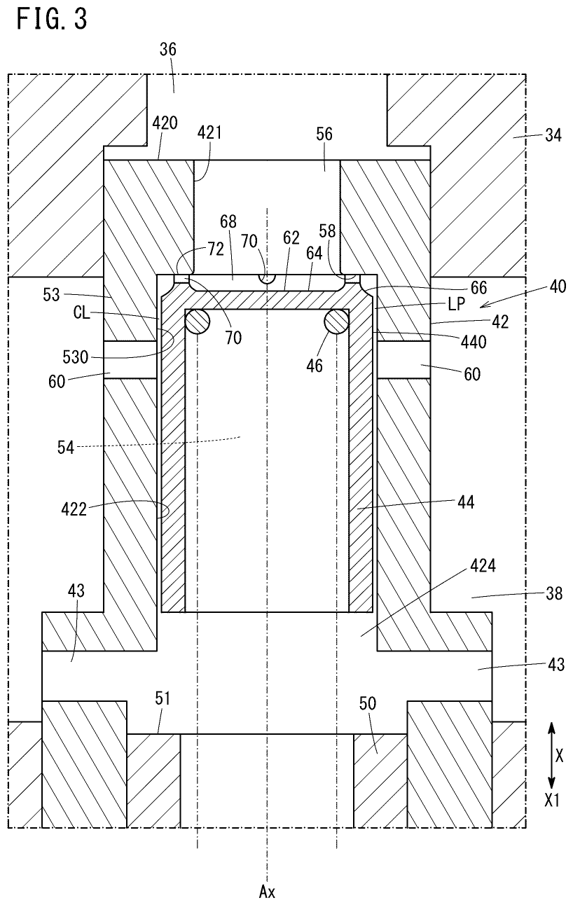

As shown in FIG. 3, the cylinder 42 is fixed to the valve support member 34 in a liquid-tight manner. The cylinder 42 is formed in a hollow tubular shape. The cylinder 42 may be cylindrical in shape. The cylinder 42 includes a peripheral wall 53, a cavity 54, an inlet 56, a valve seat 58, and an outlet 60. The peripheral wall 53 extends in the axial direction (X direction) of the cylinder 42. The peripheral wall 53 surrounds the cavity 54. The cavity 54 is formed inwardly of the peripheral wall 53. At least a portion of the peripheral wall 53 is disposed in the outflow passage 38 of the valve support member 34.

The inlet 56 is provided at one end of the peripheral wall 53. The inlet 56 communicates with the cavity 54. The inlet 56 extends in the axial direction at one end portion of the cylinder 42. The inlet 56 opens in one end surface 420 of the cylinder 42. The inlet 56 communicates with the inflow passage 36 of the valve support member 34. The shape of the inlet 56 as viewed in the axial direction may be circular. The diameter of the inlet 56 is smaller than the diameter of the cavity 54.

On the cavity 54 side, the valve seat 58 surrounds the inlet 56. In the cylinder 42, the valve seat 58 is a stepped surface between an inner peripheral surface 421 surrounding the inlet 56 and an inner peripheral surface 422 surrounding the cavity 54. The valve seat 58 is annular and centered on the axis Ax of the cylinder 42.

The outlet 60 may be in communication with the inlet 56 via the cavity 54. The outlet 60 extends through the peripheral wall 53 in the radial direction of the cylinder 42. The outlet 60 communicates with the outflow passage 38 of the valve support member 34. The outlet 60 is provided at a position spaced from the valve seat 58 in the axial direction. A plurality of outlets 60 are provided at intervals in the peripheral direction of the cylinder 42. Only one outlet 60 may be provided.

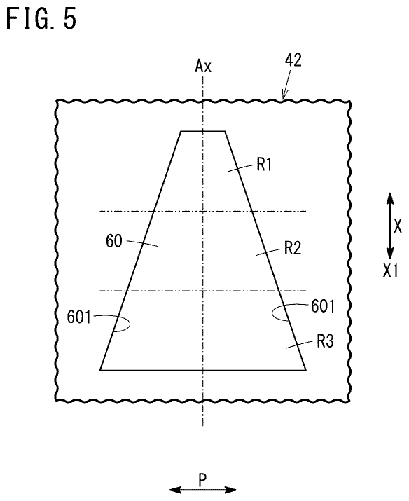

As shown in FIG. 5, the outlet 60 is formed with a first region R1, a second region R2, and a third region R3 in this order in a direction away from the valve seat 58 (see FIG. 3) along the axial direction (X1 direction). The first region R1, the second region R2, and the third region R3 are regions of the outlet 60 virtually divided into three equal parts in the axial direction. The first region R1, the second region R2, and the third region R3 are virtually divided regions, and are not physically disconnected from each other. The first region R1, the second region R2, and the third region R3 collectively form one outlet 60.

When viewed perpendicularly to the peripheral direction (P direction) of the cylinder 42, the opening width of the outlet 60 gradually increases in the X1 direction. In the peripheral direction of the cylinder 42, the opening width of the first region R1 is smaller than the opening width of the second region R2 and the opening width of the third region R3. The opening width of the third region R3 is equal to or larger than the opening width of the second region R2 in the peripheral direction of the cylinder 42. In FIG. 5, the outlet 60 is formed in a substantially triangular shape or a substantially trapezoidal shape when viewed in the radial direction of the cylinder 42. Therefore, the outlet 60 has a pair of inclined portions 601 inclined with respect to the axis Ax of the cylinder 42. The shape of the outlet 60 is not limited to a substantially triangular shape or a substantially trapezoidal shape. Therefore, the opening widths of the second region R2 and the third region R3 may be the same as each other. The shape of the outlet 60 may be other shapes such as a substantially circular shape and a substantially rectangular shape.

In FIG. 3, the valve element 44 is displaceable in the axial direction of the cylinder 42 in the cavity 54. The valve element 44 may be hollow. The valve element 44 may be cylindrical in shape.

The valve element 44 has a head portion 62. The head portion 62 is provided with a seating face 72 facing the valve seat 58. As shown in FIG. 3, the seating face 72 abuts on the valve seat 58 in the valve closed state. The valve element 44 is axially displaceable between the valve seat 58 of the cylinder 42 and the one end surface 51 of the holder 50. That is, the stroke end of the valve element 44 on the valve closing side is defined by the valve seat 58. The stroke end of the valve element 44 on the valve opening side is defined by the one end surface 51 of the holder 50.

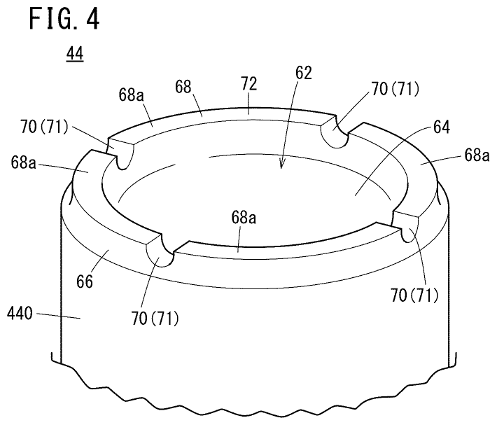

As shown in FIG. 4, the head portion 62 of the valve element 44 has a first surface 64, a second surface 66, a protrusion 68, and a passage 70. The first surface 64 may have a round shape. The first surface 64 is a portion of the head portion 62 of the valve element 44 that is located inwardly of the protrusion 68. The second surface 66 may have an annular shape along the peripheral direction of the valve element 44. The second surface 66 is an outer peripheral portion of the head portion 62 of the valve element 44. A seating face 72 is formed on a protruded end surface of the protrusion 68. The protrusion 68 extends along the circumferential direction of the valve element 44. The protrusion 68 may be an annular projection extending along the peripheral direction of the valve element 44.

As shown in FIG. 3, the first surface 64 faces the inlet 56 of the cylinder 42 in the axial direction. The second surface 66 faces the valve seat 58 in the axial direction. The protrusion 68 projects toward the valve seat 58 from between the first surface 64 and the second surface 66.

As shown in FIG. 4, the passage 70 is provided in the protrusion 68. The passage 70 connects the first surface 64 and the second surface 66. One end of the passage 70 opens on the inner peripheral side of the annular protrusion 68. The other end of the passage 70 opens on the outer peripheral side of the annular protrusion 68. The passage 70 is a cutout groove 71 provided in the protrusion 68. The passage 70 is recessed from the seating face 72. A plurality of passages 70 are provided at intervals in the peripheral direction of the valve element 44. The annular protrusion 68 is divided into a plurality of arc-shaped ribs 68a by the plurality of passages 70.

In FIG. 3, a clearance CL allowing the flow of the liquid is formed between the inner peripheral surface 530 of the peripheral wall 53 and the outer peripheral surface 440 of the valve element 44. The clearance CL is a minute gap formed by a difference between an inner diameter of the peripheral wall 53 (a diameter of the cavity 54) and an outer diameter of the valve element 44. In a valve seated state where a seating face 72 of the valve element 44 abuts on the valve seat 58, the inlet 56 and the outlets 60 communicate with each other via the clearance CL.

The spring member 46 urges the valve element 44 toward the valve seat 58 of the cylinder 42. The spring member 46 extends along the axial direction of the cylinder 42. The spring member 46 may be a coil spring. One end of the spring member 46 may be inserted into the valve element 44.

As shown in FIG. 2, the spring receiving portion 48 supports the other end of the spring member 46. The spring receiving portion 48 is provided in the hollow holder 50. The spring receiving portion 48 is axially displaceable inside the holder 50. The spring receiving portion 48 is slidable in a liquid-tight manner with respect to the inner peripheral surface of the holder 50. The holder 50 is fixed to the cylinder 42 in a liquid-tight manner. The holder 50 accommodates a part of the spring member 46.

The adjustment member 52 adjusts the length of the spring member 46 (spring length) in the cylinder 42 and the holder 50. The valve opening pressure of the relief valve 40 can be adjusted by adjusting the spring length. The adjustment member 52 is inserted into the holder 50. One end of the adjustment member 52 abuts on the spring receiving portion 48. The adjustment member 52 is a bolt. The adjustment member 52 is screwed into a nut 49 fixed to the holder 50. The length of the spring member 46 may be adjusted by setting the thickness (length) of the spring receiving portion 48 without providing the adjustment member 52.

The relief valve 40 configured as described above operates as follows.

When the pressure of the liquid flowing through the supply line 16 is equal to or lower than the set value, the relief valve 40 maintains the closed state. That is, as shown in FIG. 3, the valve element 44 is in a valve seated state in which the seating face 72 abuts on the valve seat 58. In the valve seated state, the first surface 64 and the second surface 66 of the head portion 62 of the valve element 44 communicate with each other via the passages 70. Therefore, in the valve seated state, the pressure of the liquid acts on not only the first surface 64 but also the second surface 66. That is, in the valve seated state, not only the first surface 64 but also the second surface 66 serves as a pressure receiving surface.

In the valve seated state, the clearance CL is formed between the inner peripheral surface 530 of the peripheral wall 53 and the outer peripheral surface 440 of the valve element 44. Therefore, the liquid that has reached the second surface 66 flows through the clearance CL and flows out from the outlets 60. That is, in the valve seated state, the cylinder 42 and the valve element 44 are not liquid-tight with respect to each other, and a small amount of liquid leaks from the outlets 60 through the minute clearance CL. In this case, the region where a portion of the inner peripheral surface 530 of the peripheral wall 53 between the valve seat 58 and the outlets 60 overlaps the outer peripheral surface 440 of the valve element 44 to form a leakage path LP of the liquid. The length of the leakage path LP along the axial direction is maximum in the valve seated state. Therefore, in the valve seated state, the fluid resistance by the leakage path LP is maximum, and the leakage amount is minimum.

When the liquid flowing through the supply line 16 exceeds a set value, the valve element 44 starts to be displaced in the axial direction (X1 direction). This set value is the cracking pressure at which the relief valve 40 starts to open. As the valve element 44 starts to be displaced, the seating face 72 of the valve element 44 is separated from the valve seat 58. With this separation, the seating face 72 starts to serve as a pressure receiving surface as well as the first surface 64 and the second surface 66. Therefore, the area of the seating face 72 is a difference in the pressure receiving area before and after the seating face 72 of the valve element 44 is separated from the valve seat 58. When the valve element 44 is displaced in the axial direction, the liquid is discharged from the space 424 in which the spring member 46 is disposed in the cylinder 42 to the outflow passage 38 via the hole 43 provided in the cylinder 42. Therefore, the displacement of the valve element 44 is not hindered.

As the pressure of the liquid flowing through the supply line 16 increases, the valve element 44 starts to be displaced. Since the pressure receiving surface formed by the first surface 64, the second surface 66, and the seating face 72 increases due to the displacement of the valve element 44, the pressure (the product of the load of the spring member 46 and the pressure receiving area) that tries to push the valve element 44 back to the seating face decreases. In this manner, the valve element 44 is further displaced. As the valve element 44 is displaced further, the load on the spring member 46 increases, and the pressure to push the valve element 44 up toward the pressure receiving surface is increased. The valve element 44 moves to an equilibrium position where the pressure of the liquid flowing through the supply line 16 balances with the pressure to push the valve element 44 up. This can increase the amount of liquid flowing through the bypass lines 32a, 32b, and 32b (see FIG. 1), and thus the pressure of the liquid flowing through the supply line 16 can be decreased to the set value or lower. Since the equilibrium position of the valve element 44 is changeable correspondingly to the change in the pressure of the liquid flowing through the supply line 16, it is possible to adapt the fluid circuit 12 to various pressure increases in which the pressure of the liquid flowing through the supply line 16 exceeds the set value.

According to the present embodiment, the following effects are obtained.

Since the head portion 62 of the valve element 44 is provided with the protrusion 68 and the passages 70, a difference in pressure receiving area before and after valve opening is reduced. Therefore, the pressure fluctuation (pressure pulsation) before and after the valve opening can be reduced, and the valve behavior can be stabilized. That is, hunting or chattering can be suppressed. Since the pressure fluctuation before and after the valve opening is reduced, for example in FIG. 1, it is not necessary to increase the performance of the feed pump 18, the motor, and the like in the fluid circuit 12 in which the relief valve 40 is installed. Further, since the pressure fluctuation before and after the valve opening is reduced, the fluid circuit 12 can be made to have the minimum necessary pressure resistance. Therefore, the fluid circuit 12 (liquid supply device 13) can be made lighter and more compact.

As shown in FIG. 4, the protrusion 68 extends along the peripheral direction of the valve element 44. According to such a configuration, the valve seating state is stabilized. The protrusion 68 has a rib structure, and easily secures the area of the seating face 72, and thus easily improves buckling resistance. Since the passages 70 are the cutout grooves 71 provided in the protrusion 68, the passages 70 can be easily formed.

As shown in FIG. 3, in the valve seated state in which the seating face 72 of the valve element 44 abuts on the valve seat 58, the inlet 56 and the outlets 60 communicate with each other via the clearance CL. According to such a configuration, since there is a certain amount of leakage in the valve seated state, it is possible to reduce a change in flow rate before and after the valve opening. Since the timing of the pressure fluctuation due to the change in the pressure receiving area and the timing of the pressure fluctuation due to the opening of the outlets 60 are shifted, the pressure fluctuation can be effectively reduced. Since the outlets 60 are provided at positions axially spaced from the valve seat 58, the fluid resistance in the clearance CL increases, and the amount of leakage in the valve seated state can be reduced to the minimum necessary.

As shown in FIG. 5, the outlet 60 is formed with the first region R1, the second region R2, and the third region R3 in this order in the direction away from the valve seat 58 (in the X1 direction, see FIG. 3) along the axial direction. In the peripheral direction of the cylinder 42, the opening width of the first region R1 is smaller than the opening width of the second region R2 and the opening width of the third region R3. The opening width of the third region R3 is equal to or larger than the opening width of the second region R2. According to such a configuration, the opening area of the outlet 60 at the initial stage of opening can be reduced. In FIG. 3, the opening area of the outlet 60 can be increased as the valve element 44 moves farther from the valve seat. Further, it is possible to effectively suppress a rapid pressure fluctuation during the movement of the valve element 44.

In relation to the above-described embodiment, the following supplementary notes are further disclosed.

### Supplementary Note 1

The relief valve (40) according to the present disclosure including: the cylinder (42) including the peripheral wall (53), the cavity (54) formed inwardly of the peripheral wall, the inlet (56) provided at one end of the peripheral wall and communicating with the cavity, the valve seat (58) surrounding, in the cavity, the inlet, and the outlet (60) communicable with the inlet via the cavity; the valve element (44) that is displaceable inside the cavity in an axial direction of the cylinder, includes the head portion (62) provided with the seating face (72) facing toward the valve seat, and abuts on the valve seat at the seating face in a state where the relief valve is closed; and a spring member (46) configured to urge the valve element toward the valve seat of the cylinder, wherein the head portion includes the first surface (64) facing toward the inlet in the axial direction, the second surface (66) facing toward the valve seat in the axial direction, the protrusion (68) protruding from between the first surface and the second surface toward the valve seat and including the seating face, and the passage (70) formed in the protrusion and connecting the first surface and the second surface.

### Supplementary Note 2

In the relief valve according to Supplementary Note 1, the protrusion may extend along the peripheral direction of the valve element, and the passage may be the cutout groove (71) provided in the protrusion.

### Supplementary Note 3

In the relief valve described in Supplementary Note 2, the protrusion may be an annular projection, and the cutout groove may be provided in plurality at intervals in the peripheral direction.

### Supplementary Note 4

In the relief valve according to Supplementary Note 1, the outlet is provided at the position spaced apart from the valve seat in the axial direction, the clearance (CL) allowing the flow of liquid is formed between the inner peripheral surface (530) of the peripheral wall and the outer peripheral surface (440) of the valve element, and the inlet and the outlet may communicate with each other via the clearance in the valve seated state where the seating face of the valve element abuts on the valve seat.

### Supplementary Note 5

In the relief valve according to any one of Supplementary Notes 1 to 4, the outlet may include the first region (R1), the second region (R2), and the third region (R3) formed in this order in a direction away from the valve seat along the axial direction, and in the peripheral direction of the cylinder, the opening width of the first region may be smaller than each of the opening width of the second region and the opening width of the third region, and the opening width of the third region may be equal to or greater than the opening width of the second region.

### Supplementary Note 6

In the relief valve described in Supplementary Note 5, the outlet may be formed in the substantially triangular shape or the substantially trapezoidal shape when viewed in the radial direction of the cylinder.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A relief valve comprising:
a cylinder including a peripheral wall, a cavity formed inwardly of the peripheral wall, an inlet provided at one end of the peripheral wall and communicating with the cavity, a valve seat surrounding, in the cavity, the inlet, and an outlet communicable with the inlet via the cavity;
a valve element that is displaceable inside the cavity in an axial direction of the cylinder, includes a head portion provided with a seating face facing toward the valve seat, and abuts on the valve seat at the seating face in a state where the relief valve is closed; and
a spring member configured to urge the valve element toward the valve seat of the cylinder, wherein
the head portion comprises:
a first surface facing toward the inlet in the axial direction;
a second surface facing toward the valve seat in the axial direction;
a protrusion protruding from between the first surface and the second surface toward the valve seat and including the seating face; and
a passage formed in the protrusion and connecting the first surface and the second surface.

2. The relief valve according to claim 1, wherein
the protrusion extends along a peripheral direction of the valve element, and
the passage is a cutout groove provided in the protrusion.

3. The relief valve according to claim 2, wherein
the protrusion is an annular projection, and
the cutout groove is provided in plurality at intervals in the peripheral direction.

4. The relief valve according to claim 1, wherein
the outlet is provided at a position spaced apart from the valve seat in the axial direction,
a clearance allowing a flow of liquid is formed between an inner peripheral surface of the peripheral wall and an outer peripheral surface of the valve element, and
the inlet and the outlet are in communication with each other via the clearance in a valve seated state where the seating face of the valve element abuts on the valve seat.

5. The relief valve according to claim 1, wherein
the outlet includes a first region, a second region, and a third region formed in order mentioned, in a direction away from the valve seat along the axial direction, and
in a peripheral direction of the cylinder, an opening width of the first region is smaller than each of an opening width of the second region and an opening width of the third region, and the opening width of the third region is equal to or greater than the opening width of the second region.

6. The relief valve according to claim 5, wherein the outlet is formed in a substantially triangular shape or a substantially trapezoidal shape when viewed in a radial direction of the cylinder.
